(19) United States
(12) Patent Application Publication
(10) Pub. No.: US 2012/0150713 A1
(43) Pub. Date: Jun. 14, 2012

(54) TRADE IMPLEMENTATION AND ANALYTICS SYSTEM

(76) Inventors: Robert RUSSEL, Greenwich, CT (US); Preston FORD, Marblehead, MA (US); Neil Adams, Richmond Hill (CA); Carter B. Ford, Boston, MA (US)

(21) Appl. No.: 13/291,863

(22) Filed: Nov. 8, 2011

Related U.S. Application Data
(60) Provisional application No. 61/410,999, filed on Nov. 8, 2010.

(51) Int. Cl. G06Q 40/04

(52) U.S. Cl. 705/37

(57) ABSTRACT

Systems and methods for normalizing the control parameters associated with trading algorithms, providing analytic data to traders in discrete time intervals to assist in the analysis of trading performance, and providing crossing opportunities to orders that have been committed to a trading algorithm but have not yet been executed, are provided. A dashboard to allow a trading professional more effective use of multiple algorithms can be created. Parameters associated with multiple algorithms can be normalized and tuned rapidly from a single user interface. Trading performance can be reviewed in discrete time intervals and execution venues. Traders can review a performance score for a trading algorithm and select an algorithm based in part on their commission budget. Block trading opportunities can be available with a crossing engine or external ATS.

### CROSS-REFERENCE TO RELATED ACTIONS

This application claims the benefit of U.S. Provisional Application No. 61/410,999 filed on Nov. 8, 2010, which is incorporated herein by reference.

### BACKGROUND

The described methods and systems generally relate to computer systems for algorithmic trading of securities, and more particularly, methods and systems for accepting a trader's insight and to normalize the control parameters associated with trading algorithms, providing analytic data to traders in discrete time intervals to assist analysis of trading performance, and providing crossing opportunities to orders that have been committed to a trading algorithm.

Algorithmic trading systems (i.e., algos) are an important part of the securities trading landscape and can be considered one of the fastest growing segments of the institutional equities market. In general, these algorithmic trading systems are viewed as convenient, productive and can greatly assist investment managers in finding liquidity and fulfilling their commission obligations. There can be, however, issues related to the control of execution details for orders released to an algorithmic server. For example, while some algorithmic servers can allow a trader to modify trading execution details through parameter modification, these current solutions are generally not practical and do not allow traders to apply their insight to the execution strategy. In general, algorithmic servers only allow the parameters to be modified for one stock at a time. Each modification can take minutes to implement which makes it impracticable for use by a busy trader who is often managing a portfolio of hundreds of names (i.e., securities).

In addition, each algorithmic server is generally associated with a particular banking institution. As a result, the parameters associated with the algorithms can be different for each bank, adding further to the complexity of modifying the implementation strategy. As a result of these difficulties, many traders have become passive in the algorithmic trading process. Orders can be sent to various algorithms with little or no value added by the trading professional.

In general, the overall performance of a trading algorithm can be evaluated at the close of trading. Based on a view of the daily performance, a particular algorithm may appear to meet the trader's expectations based on predetermined thresholds. Through the day, however, the actual performance of the algorithm may exceed these threshold values. Traders would benefit from the ability to receive alerts whenever an algo is operating outside predefined thresholds, and then review such an anomaly in a narrow space of time (i.e., minutes) to better understand the market forces that may be behind the anomaly. It would also be desirable to score different algos on a relative scale based on their performance during a defined time interval.

In a typical trading system, a trader can send orders to an algo server via a standard message (e.g., via the FIX protocol). Within the trader's Order Management System (OMS), the orders are identified as committed but not yet executed. In general, these committed orders are not directly visible to alternative trading systems (ATS) (e.g., dark pools) because these systems look for open orders on the OMS. Thus, to the extent any orders committed to algo will have an opportunity in a dark pool, it is limited to the extent the algo participates in such sources of liquidity. As a result, opportunities to trade in an ATS may be lost. It would be desirable to allow a trader to directly access the liquidity in an ATS for the orders that are committed to an algo, but not yet executed.

### SUMMARY

An example of a computerized method for adjusting the performance of a plurality of trading algorithms includes: storing algorithm tuning parameters, receiving a change request to adjust the tuning parameters of one or more algorithms, determining new tuning parameters for the one or more algorithms based at least on the change request and the stored algorithm tuning parameters, and transmitting the new tuning parameters.

Implementations of such a computerized method may include one or more of the following features. The change request includes a name of a strategy to be employed by the algorithm, and the name of the strategy can be VWAP, TWAP, Go Along, Arrival Price, Sniper, Guerilla, or Stealth. The change request can include a speed and tracking parameter. Transmitting the new tuning parameters includes transmitting the new parameters to one or more algorithm servers and an OMS via a FIX message.

An example of a computerized method for providing subscription based analytic data to a trader includes: storing trader subscription information including a security of interest; monitoring a market feed for executions involving the security of interest; storing execution information including a timestamp, price, quantity and venue for each of the executions involving the trader and the security of interest; determining a market data information for the security of interest including a last trade information, a next trade information, and a market volume for a timeframe around the timestamp in the stored execution information; and sending the execution information and the market data information to a data source that can be accessed by the trader.

Implementations of such a computerized method may include one or more of the following features. The market data information for the security of interest includes best offer quantity and price and best bid quantity and price in the execution venue for the timeframe around the timestamp in the stored execution information. The market data information for the security of interest includes best offer quantity and price and best bid quantity and price in more than one venue for the timeframe around the timestamp in the stored execution information. The market data information for the security of interest includes the next best offer quantity and price and the next best bid quantity and price for a timeframe around the timestamp in the stored execution information. The market data information includes a price, a quantity and a venue of the previous and subsequent trades of the security of interest. The timeframe around the timestamp in the stored execution information includes two updates before the execution and 5 updates after the execution. An OMS is a data source that can be accessed by the trader. A networked relational database system is a data source that can be accessed by the trader. An alert is sent to the trader based on the execution information and the market data information.

An example of a computerized method for providing a crossing opportunity for an order for a security that is committed to a trading venue includes: receiving a working order information comprising an order for a security that is committed to a trading venue but not yet executed; identifying a contra order based on at least on a portion of the working order information; transmitting a stop working message comprising instructions to cancel at least a portion of the order previously committed to the trading venue; receiving information regarding the execution of all, some or none of the order; and transmitting a continue working message configured to commit at least part of the remainder of the order to the trading venue, if a part of the order was not executed.

Implementations of such a computerized method may include one or more of the following features. Identifying a contra order includes: providing at least a portion of the working order information to a crossing system; and receiving an indication of interest for a contra order from the crossing system. An alert is sent to a trader to inform them of the contra order, and an indication of the trader's attempt to execute a trade based on the contra order is received. The continue work message is sent to an OMS.

In accordance with implementations of the invention, one or more of the following capabilities may be provided. A dashboard to allow a trading professional more effective use of multiple algorithms can be created. Parameters associated with multiple algorithms can be normalized and tuned rapidly from a single user interface. A trader's professional insight can be used to modify parameters associated with one or more algorithms across one or more industry segments. Intra-day performance of an algorithm, and the corresponding trader insight, can be analyzed. Trading performance can be reviewed in discrete time intervals. Opportunistic block trading can be realized. A single, lightweight user interface can provide access to multiple bank algorithms. Standard FIX messaging protocols can be used to transfer order information into and out of the Trade Implementation and Analytics system. Execution tools can allow the trader to quickly modify trading strategy in near real time for algorithm providers. Analysis tools can be used to monitor trading performance in near real time through discrete time window analysis. Traders can automatically avail themselves of block trading opportunities in an ATS without modifying their work flow.

The subject matter disclosed herein provides methods and apparatus, including computer program products, for implementing strategies in algorithmic trading. Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

These and other capabilities of the invention, along with the invention itself, will be more fully understood after a review of the following figures, detailed description, and claims.

### BRIEF DESCRIPTION OF THE FIGURES

FIG. 1A is an exemplary component model diagram of an implementation of the Trade Implementation and Analytics system.

FIGS. 1B and 1C depict an exemplary computer system which can be used to practice an embodiment of the Trade Implementation and Analytics system.

FIG. 2 is a block diagram illustrating an embodiment for an order and parameter routing process.

FIG. 3 is a block diagram illustrating an embodiment for a parameter routing process.

FIG. 4 is an exemplary flow diagram of a process for normalizing algorithmic trading parameters.

FIG. 5 is an exemplary flow diagram of a process for providing subscription based analytic data to a trader.

FIG. 6 is an exemplary flow diagram of a process for providing crossing opportunities to orders currently committed to banking algorithms.

FIG. 7 is an exemplary user interface for implementing the Trade Implementation and Analytics system across an industry group.

FIG. 8 is an exemplary Trade Implementation and Analytics system user interface illustrating selectable orders within a plurality of industry groups.

FIG. 9 is an exemplary Trade Implementation and Analytics system user interface illustrating parameter adjustment across multiple orders and multiple trading algorithms.

FIG. 10 is an exemplary Trade Implementation and Analytics system user interface illustrating an alert of a block crossing opportunity.

FIG. 11 is an exemplary user interface for implementing the Trade Implementation and Analytics system across a collection of names, including a control to configure alerts for one or more of the names.

FIG. 12 is an exemplary user interface for setting alerts in the Trade Implementation and Analytics system.

FIG. 13 is an exemplary user interface for alerting a trader using the Trade Implementation and Analytics system.

FIGS. 14A and 14B are exemplary model windows in a user interface for alerting a trader using the Trade Implementation and Analytics system.

FIG. 15 is an exemplary Trade Implementation and Analytics system user interface illustrating discrete time analysis of the performance of an algorithm associated with one or more orders.

FIG. 16 is an exemplary user interface for reviewing execution venue information associated with a name and time interval.

### DETAILED DESCRIPTION OF PREFERRED EMBODIMENTS

Embodiments of the invention provide techniques for normalizing the control parameters associated with trading algorithms, providing analytic data to traders in discrete time intervals to assist in the analysis of trading performance, and providing crossing opportunities to orders that have been committed to a trading algorithm but have not yet been executed. The system is exemplary, however, and not limiting of the invention as other implementations in accordance with the disclosure are possible.

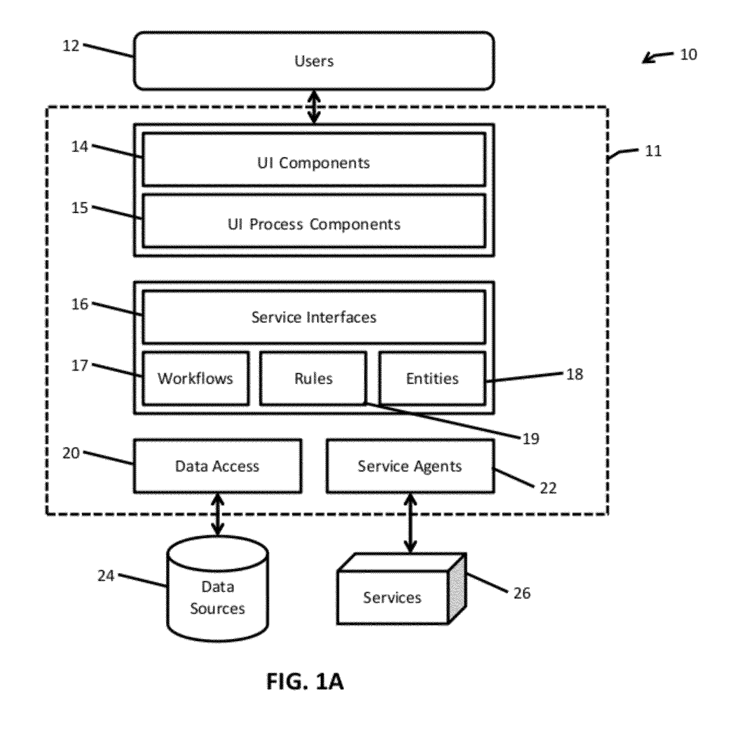

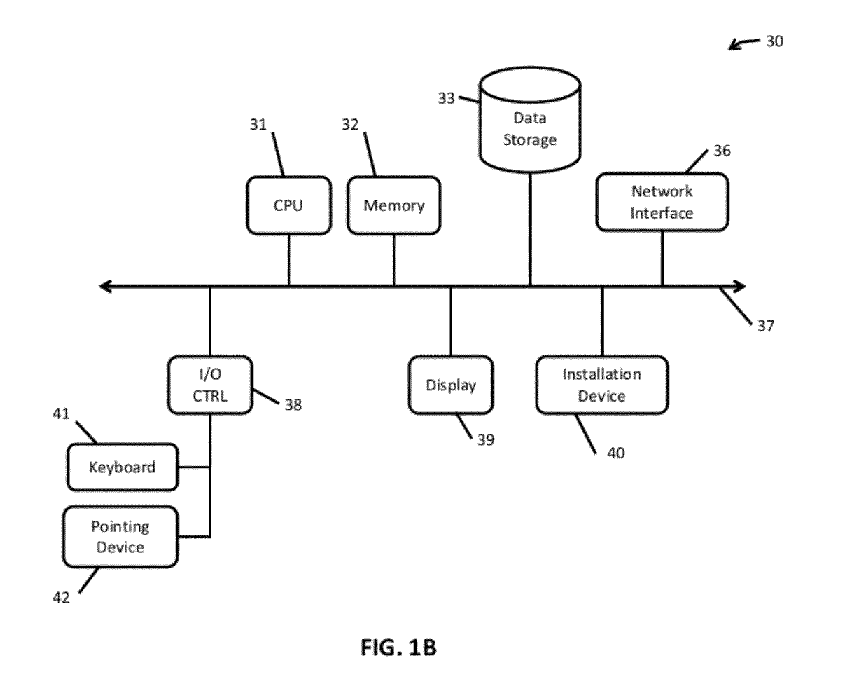

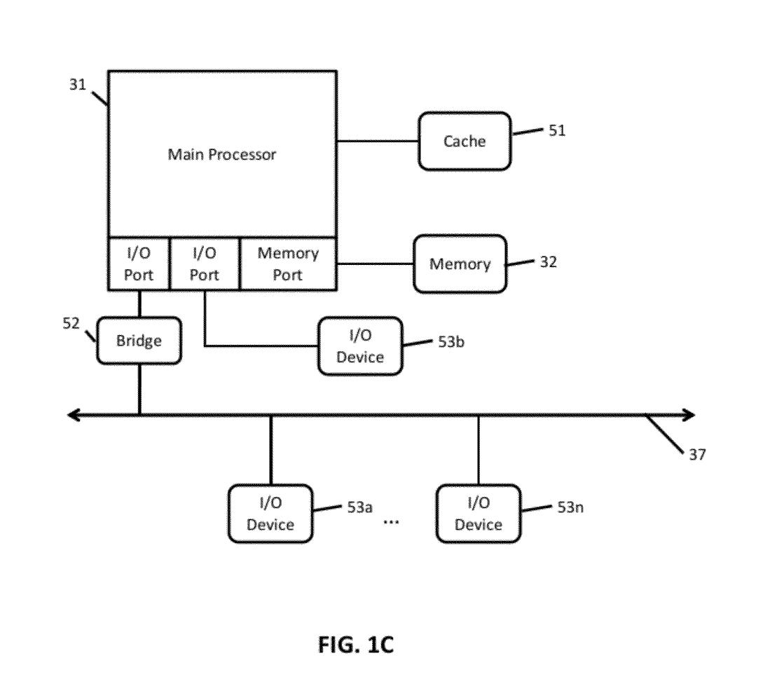

Referring to FIG. 1A, an exemplary component model diagram 10 of an implementation of the Trade Implementation and Analytics system is shown. The component model diagram 10, however, is exemplary only and not limiting. The component model diagram 10 may be altered, e.g., by having components added, removed, or rearranged. The term ‘component’ is used to mean a piece or part of the Trade Implementation and Analytics implementation. Examples of components include compiled software components (e.g., Microsoft .NET assemblies), and other software entities such as relational database system, web servers, web services, and communication processes (e.g., FIX messaging). In general, components can include computer-readable instructions disposed on a computer-readable medium. The component model 10 can include an application 11, users 12, data sources 24 and services 26. The application 11 can include known programming components such as User Interface (UI) components, 14, UI process components 15, Service Interfaces 16, Workflows 17, Rules 19, Entities 18, Data Access 20, and Service Agents 22. In general, a typical user 12 of the Trade Implementation and Analytics system is a buyside trader, but other users may also utilize the application 11. In an embodiment, the application 11 is compatible with third party operation systems and program environments (e.g., Microsoft .NET platform). Examples of Data Sources 24 and Services 26 include the databases associated with third party OMS and EMS implementations (e.g., Eze Castle, ITG, Linedata, Bloomberg, Portware, Advent), industry trade execution data (market feeds) and news sources (e.g., Bloomberg, Reuters), Alternative Trading venues (e.g., Blockcross, Liquidnet, ITG), and proprietary algorithmic trading systems (e.g., Goldman, Mogan Stanley). Connections to other data sources and service providers may also be utilized.

In general, the UI components 14 provide a way for users 12 to interact with the application 11. In an embodiment, the users 12 interact with objects supported by the Microsoft Windows® operating system. The UI components 14 can include Windows Forms, Web pages, controls or any other technology used to provide and receive data to and from the users 12. The UI process components 15 can include logic operations to help synchronize and manage the user interaction processes. For example, the Trade Implementation and Analytics system can sort and display order information based on industry groups, user name, selection status, and other variables. The process flow and state management logic can be included in the UI process components rather than hard coded in the UI components 14. The UI process components 15 can also be used to customize the User Interface for different implementations of the Trade Implementation and Analytics system. For example, in an embodiment, the application 11 can be installed on a user's OMS or EMS system. The UI process components can be customized to operate within these environments.

The workflows component 17 can be used to define the process steps required to manage the data flow associated with the user's input. For example, if a user 12 selects a normalization parameter for a particular algorithm, then the workflow component can be utilized to manage the tasks of converting the user's selection into a message to be sent to the corresponding algorithm server. The rules component 19 can be used to perform application tasks. Continuing the example above, once the normalization parameters are received from the user, the rules component can implement the functionality that determines the appropriate new values for the algorithm parameters. The entities component 18 can be used to handle the data that must be passed between components. The entities can be data structures such as DataSets, DataReaders, or XML streams. Other object-oriented classes may also be used. The entities component 18 can be used to support a dispersed installation of the application, such that different components are installed on different networked computers.

The service interfaces 16 can be used to support the communication requirements into and out of the application 11 (e.g., message-based communication, formats, protocols, security, exceptions). For example, the communication requirements can vary based on OMS/EMS vendors, algorithm server, and institutional users 12 (e.g., proprietary Application Program Interfaces (APIs), FIX, Stored procedure queries, Web Services). The service agents 22 can be used to manage the semantics of communicating with a particular service 26. In an embodiment, the service agents 22 provide a mapping between the format of data in the service 26, and the format required by the application 11.

In general, the components in the application 11 can be customized to support different embodiments of the Trade Implementation and Analytics system. For example, the application 11 can be configured to be installed on a user's existing OMS or EMS system. The application 11 can be configured to run on a networked server, which can be located locally or remotely from a user 12. The components need not persist on the same computer system. For example, custom UI components 14 can be installed on a user's existing computer systems and configured to maintain the look and feel of the existing system.

Referring to FIGS. 1B and 1C, block diagrams of a computing device 30 which may be useful for practicing an embodiment of the Trade Implementation and Analytics system are shown. The Trade Implementation and Analytics system can include one or more applications 11 that may be deployed as and/or executed on any type and form of computing device, such as a computer, network device, server, database, or appliance capable of communicating on any type and form of network and performing the operations described herein. Each computing device 30 can include a central processing unit 31, and a main memory unit 32. As shown in FIG. 1B, a computing device 30 may include a visual display device 39, a keyboard 41 and/or a pointing device 42, such as a mouse, touch pad, or touch screen. Referring to FIG. 1C, each computing device 30 may also include additional optional elements, such as one or more input/output devices 53a-53b (generally referred to using reference numeral 53), and a cache memory 51 in communication with the central processing unit 31.

The central processing unit 31 is any logic circuitry that responds to and processes instructions fetched from the main memory unit 32. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor; those manufactured by International Business Machines of White Plains, N.Y.; or those manufactured by Advanced Micro Devices of Sunnyvale, Calif. The computing device 30 may be based on any of these processors, or any other processor capable of executing the instructions comprising the application 11.

Main memory unit 32 may be one or more memory chips capable of storing data and allowing any storage location to be directly accessed by the microprocessor 31, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 32 may be based on any of the above described memory chips, or any other available memory chips capable of operating as described herein. In the embodiment shown in FIG. 1B, the processor 31 communicates with main memory 32 via a system bus 37. In an embodiment, the processor 31 communicates directly with main memory 32 via a memory port. For example, in FIG. 1C the main memory 32 may be DRDRAM.

FIG. 1C depicts an embodiment in which the main processor 31 communicates directly with cache memory 51 via a secondary bus, sometimes referred to as a backside bus. In other embodiments, the main processor 31 communicates with cache memory 51 using the system bus 37. Cache memory 51 typically has a faster response time than main memory 32 and is typically provided by SRAM, BSRAM, or EDRAM. In an embodiment, the processor 31 communicates with various I/O devices via a local system bus 37. Various busses may be used to connect the central processing unit 31 to any of the I/O devices, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 39, the processor 31 may use an Advanced Graphics Port (AGP) to communicate with the display 39. FIG. 1C depicts an embodiment of a computer 30 in which the main processor 31 communicates directly with I/O device 53b via HyperTransport, Rapid I/O, or InfiniBand. FIG. 1C also depicts an embodiment in which local busses and direct communication are mixed: the processor 31 communicates with I/O device 53a using a local interconnect bus while communicating with I/O device 53b directly.

The computing device 30 may support any suitable installation device 40, such as, a CD-ROM drive, a CD-R/RW drive, a DVD-ROM drive, tape drives of various formats, USB device, hard-drive, network connection, or any other device suitable for installing software and programs, or portion thereof. The computing device 30 may further comprise a storage device 33, such as one or more hard disk drives or redundant arrays of independent disks, for storing an operating system and other related software, and for storing application components. Optionally, any of the installation devices 40 could also be used as the storage device 33 (i.e., cloud based storage). Additionally, the operating system and the software can be run from a bootable medium, for example, a bootable CD, such as KNOPPIX®, a bootable CD for GNU/Linux that is available as a GNU/Linux distribution from knoppix.net.

The computing device 30 may include a network interface 36 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 36 may comprise a built-in network adapter, network interface card, PCMCIA network card, card bus network adapter, wireless network adapter, USB network adapter, modem or any other device suitable for interfacing the computing device 30 to any type of network capable of communication and performing the operations described herein.

A wide variety of I/O devices 53a-53n (not all shown) may be present in the computing device 30. Input devices include keyboards, mice, trackpads, trackballs, microphones, and drawing tablets. Output devices include video displays, speakers, inkjet printers, laser printers, and dye-sublimation printers. The I/O devices 53 may be controlled by an I/O controller 38 as shown in FIG. 1B. The I/O controller may control one or more I/O devices such as a keyboard 41 and a pointing device 42, e.g., a mouse or optical pen, touch pad, touch screen. Furthermore, an I/O device may also provide storage 33 and/or an installation medium 40 for the computing device 30. In still other embodiments, the computing device 30 may provide USB connections to receive handheld USB storage devices such as the USB Flash Drive line of devices manufactured by Twintech Industry, Inc. of Los Alamitos, Calif.

In some embodiments, the computing device 30 may comprise or be connected to multiple display devices, which each may be of the same or different type and/or form. As such, any of the I/O devices and/or the I/O controller may comprise any type and/or form of suitable hardware, software, or combination of hardware and software to support, enable or provide for the connection and use of multiple display devices by the computing device 30. For example, the computing device 30 may include any type and/or form of video adapter, video card, driver, and/or library to interface, communicate, connect or otherwise use the display devices. In one embodiment, a video adapter may comprise multiple connectors to interface to multiple display devices. In other embodiments, the computing device 30 may include multiple video adapters, with each video adapter connected to one or more of the display devices. In some embodiments, any portion of the operating system of the computing device 30 may be configured for using multiple displays. In other embodiments, one or more of the display devices may be provided by one or more other computing devices, such as computing devices connected to the computing device 30, for example, via a network. These embodiments may include any type of software designed and constructed to use another computer's display device as a second display device for the computing device 30. One ordinarily skilled in the art will recognize and appreciate the various ways and embodiments that a computing device 30 may be configured to have multiple display devices.

In an embodiment, an I/O device may be a bridge 52 between the system bus 37 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device 30 of the sort depicted in FIGS. 1B and 1C typically operate under the control of operating systems, which control scheduling of tasks and access to system resources. The computing device 30 can be running any operating system such as any of the versions of the Microsoft®. Windows operating systems, the different releases of the Unix and Linux operating systems, any version of the Mac OS® or OS X for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS XP, WINDOWS VISTA, WINDOWS Server and WINDOWS 7 all of which are manufactured by Microsoft Corporation of Redmond, Wash.; MacOS and OS X, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, (such as those versions of Unix referred to as Solaris/Sparc, Solaris/x86, AIX IBM, HP UX, and SGI (Silicon Graphics)), among others. In other embodiments, the computing device 30 may have different processors, operating systems, and input devices consistent with the device. Moreover, the computing device 30 can be any workstation, database, desktop computer, laptop or notebook computer, server, handheld computer, mobile telephone, smart phone, any other computer, or other form of computing or telecommunications device that is capable of communication and that has sufficient processor power and memory capacity to perform the operations described herein.

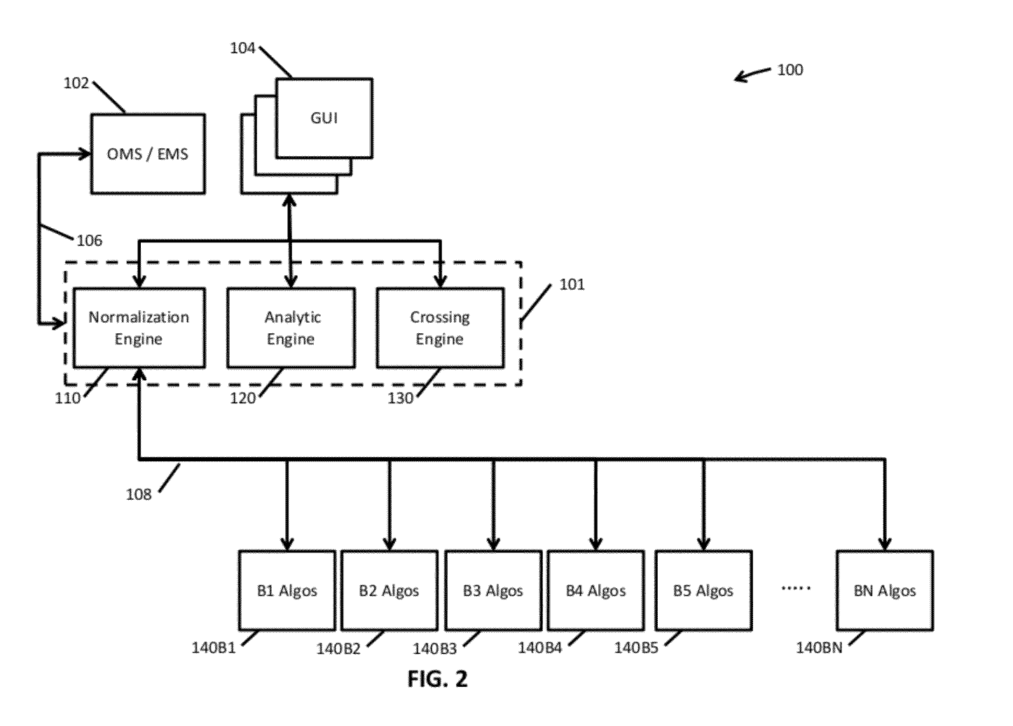

Referring to FIG. 2, a block diagram illustrating an embodiment for an order and parameter routing process 100 is shown. In an embodiment, the Trade Implementation and Analytics system 101 includes a Normalization Engine (N-engine) application 110, and Analytic Engine (A-engine) application 120, and a Crossing Engine (C-engine) application 130. In other embodiments, the Trade Implementation and Analytics system 101 can include only 1 or 2 of the applications (e.g., the system 101 can be only the N-engine 110, only the A-engine 120, both the N-engine 110 and the A-engine 120, or other combinations). Referring back to FIG. 1, in an embodiment, the N-engine 110, the A-engine 120, and the C-engine 130 can share one or more components described in the component model diagram 10. In general, the process 100 includes a connection to one or more OMS and/or EMS systems 102 (generally referred to as an OMS 102), a Graphic User Interface 104, a communication link 106 between the OMS 102 and the Trade Implementation and Analytics system 101, a connection to one or more algorithmic trading systems servers 140B1-140BN (n.b, the term algos 140 is used throughout this specification to generally mean the algorithmic trading systems servers and the corresponding algorithmic trading programs that can be executed on those servers), and a communication link 108 between the Trade Implementation and Analytics system 101 and the algos 140. In an embodiment, the Trade Implementation and Analytics system 101 and OMS 102 are computer systems located at a client site, but the process 100 need not be so limited. The OMS system 102 and the Trade Implementation and Analytics system 101 can be disposed remote from one another, and configured to communicate over a network (e.g., via the data access 20 and/or service agent 22 components). For example, the systems can communicate using FIX messaging protocol or an established API. The Trade Implementation and Analytics system 101 can also be in communication with a plurality of algorithmic servers 140 and other Alternative Trading Systems (not shown). The algorithmic servers 140 are typically located in a service site such as a bank or other institution.

In general, the process 100 provides a mechanism by which traders can house their orders, send orders to their destination, and organize their orders in a way so they can normalize and adjust existing institutional algorithms to enhance trading performance across a plurality of the destinations.

In an embodiment, the N-engine 110, in conjunction with a GUI 104, can allow a trader to manipulate parameters associated with several algorithmic strategies in near real time. As an example, and not a limitation, algorithmic strategies can include names Arrival Price, Go Along, and VWAP/TWAP, Sniper, Guerilla, Stealth, and other proprietary names. These algorithms generally include one or more parameters which can be used to modify their execution performance. For example, if a trader has insight that an equity price is increasing, and the trader is utilizing an algorithm to buy that stock, then the trader could achieve better results by trading a little faster. Conversely, if the trader's insight was for a lower price, they would trade a little slower. The Trade Implementation and Analytics system 101 can allow the trader to simply and quickly adjust the algorithm parameters, for one or a group of names, in order to modify the targeted distribution of the shares over time.

The implementations of the N-engine 110 can be local (i.e., on the OMS 102, on a dedicated server at a client's location), or it could be remote (i.e., residing in an offsite datacenter). In an embodiment, the N-engine 110 does not need information about the name, the side, or the size of the trade. The N-engine can receive a request from a user to change the parameters for one or more orders. For example, if a user has 50 orders on their blotter, and some event happens in the market, the user may want the algos 140 corresponding to those orders to go faster. The OMS can send a query to the N-engine 110, the N-engine can then provide the parameters for all algos associated with the orders. In an embodiment, the adjustments can be made by selecting the individual orders (i.e., by highlighting a group of orders), or by selecting a group (i.e., an industry group).

Referring to FIG. 2, with further reference to FIG. 1A, in an embodiment, the process 100 provides that the OMS 102 can route orders through the communication link 106 and through the N-engine 110. A user 12 can utilize GUI 104 to select orders and modify the corresponding algo parameters. In an embodiment, the GUI 104 can be on the Trade Implementation and Analytics application 101. In another embodiment, the GUI 104 can be integrated with the OMS 102. The N-engine 110 is line to receive the orders and pass the orders to the algos 140. The Trade Implementation and Analytics application 101 is aware of the working order information (e.g., name, quantity, side, etc.) because the orders are passing through the N-engine 110. The N-engine 110 is also in line on the return information (i.e., the executions) via the communication link 108. In this embodiment, the N-engine 110 is aware of the order details (e.g., quantity, side, how much is complete). The corresponding executions also flow through the N engine back to the OMS. In an embodiment, the N-engine 110 is an application 11 running on the user's OMS 102 and thus the user can maintain control of the dissemination of the order details.

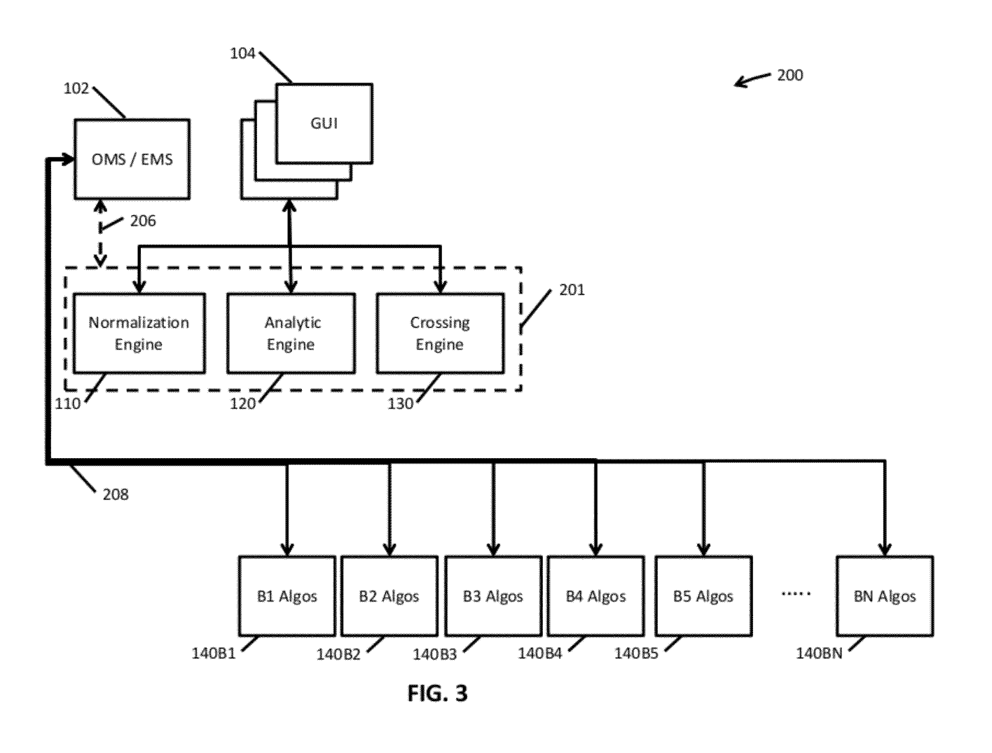

Referring to FIG. 3, with further reference to FIG. 2, a block diagram illustrating an embodiment for a parameter routing process 200 is shown. The process 200 varies from the process 100 in that the N-engine 110 of the Trade Implementation and Analytics application 201 may not receive the order information flowing from the OMS 102. Rather, the OMS 102 queries the N-engine 110 via the communication link 206 for the appropriate algo parameters. For example, the OMS can query the algo parameters based on desired performance changes for one or more orders (i.e., go 5% faster on these orders). In response, the N-engine returns the parameters to the OMS 102 via the communication link 206. The OMS 102 can be configured to utilize the returned parameters to create a FIX message, for example, to send directly to the algos 140 via the communication link 208. In an embodiment, the query sent to the N-engine 110 from the OMS 102 may include the current algo parameters for the order (i.e., the parameters the working order is currently using). The reply from the N-engine 110 to the OMS 102 can include the components the OMS 102 will use in their message to the algos 140. The exact content and interaction with each of the algos 140 will vary based on the algos being used. For example, some algos 140 allow changes to be entered for orders that are actively working, while others require canceling the current order and resubmitting the new order (i.e., with the new parameters).

In an embodiment, the N-engine 110 can validate the changes requested by the user to determine if pre-programmed rules associated with the algos 140 may be violated. For example, the N-engine 110 can compare the current state of the algo variables with the desired state to determine if they violate the reasonable percentage test, which will cause an algo 140 to reject the order (i.e., the order is violating the algos parameter guidelines). In this embodiment, the Trade Implementation and Analytics application 201 receives working order information that is a subset of the order information on the OMS. For example, the working order information can be limited to the order information required to validate the requested changes to an algorithm parameter in view of institutional parameter guidelines. Other validation steps such a verifying domain, liquidity thresholds based on name, and Average Daily Volume (ADV) bucket assignments can be used. In general, the algo parameters, and corresponding validation rules (if any), can be collected through off-line research and then updated to a parameter database which is accessible by the N-engine 110. Additional correlations for each algo 140 can be implemented. For example, performance parameters can be determined based on one or more input variables (e.g., ADV and Industry).

In an embodiment, the A-engine 120 provides users the ability to look at their trade data in intervals of time, and compare that view to the overall market. For example, with reference to FIG. 1A, a user 12 can establish a subscription account to receive data (i.e., the names that the user is interested in). The A-engine 120 can be configured (i.e., via the rules component 19) to provide trade data to the user at a desired interval (i.e., every execution, every n executions, once a minute, every 2 minutes, etc.). In an embodiment, the A-engine 120 can utilize a service agent 22 to monitor market data. When a subscribers trades are detected (e.g., trades involving the names of interest that are received from the algo or the OMS via a FIX message, drop copy, or other communication), the A-engine 120 can gather the execution information including a timestamp, price, quantity and venue for trade executions. The A-engine 120 can also retrieve broader market information from a service 26 (e.g., Reuters, Bloomberg, etc.), and provide the information to the user to help put their trades in a larger context. For example, the information transmitted to the user can be the overall volume in the market over a small period of time around the trades of interest.

In an embodiment, the A-engine 120 can be configured to present market and trade data over a discrete interval of time and thereby allow the subscriber to make an assessment as to the performance of their trading activities. For example, the A-engine 120 can gather the volume of a particular security the user is trading as compared to the overall volume of that security. The rules component 19 can be configured to compare the volume information with previously stored threshold values. In operation, if the user is above or below a desired threshold, then A-engine 120 can be configured (e.g., via the workflow component 17) to alert the user to the fact that the threshold conditions are being violated within a given time interval. In an embodiment, when the user receives the alert, they can select the security (e.g., name that is the subject of the alert), and the GUI 104 can display a time based graph of when the violation occurred.

The alert process can help focus the user's attention on a smaller time period to evaluate the performance of their selected algorithmic trading routines. By identifying, and then alerting the user, whenever the performance of an algo is outside of the proscribed thresholds within a subset of the trading day, including the order timeframe, the user can conduct additional research to determine why the violations are occurring. That is, the smaller time increment window can substantially narrow down the amount of external data the user must review to complete their analysis. The alerts from the A-engine 120 can help the user recognize suspicious trading activity. For example, suppose an algo is buying on the bid for 80% of the trades. This could mean the market was coming toward the user and thus the algo was actually causing the user to hold the market up. This type of analysis is not readily available at the customer level. The process 100 can also provide other benefits based on different analysis scenarios.

In addition to the algorithm tuning aspects of the N-engine 110, and the analytic aspects of the A-engine 120, embodiments of the Trade Implementation and Analytics system 101 can also provide for implementing block trading opportunities for committed orders which are active on one or more algorithmic servers 140 via the C-engine 130. In general, traders can be frustrated by small average execution sizes and high turnover trading strategies since these factors can negatively affect their performance. While participation in block trading venues (e.g., dark pools, ATS) can be useful, it often requires either delaying the start of the order or holding back some portion of the order (i.e., not committing the order). This can be a useful strategy, but it can also complicate the traders overall workflow and increases the interfaces to alternative destinations. The Trade Implementation and Analytics system 101 can provide an approach to the way orders participate in block trading opportunities. For example, with the Trade Implementation and Analytics system 101, the trader does not need to delay the start or hold back a portion of their order.

In general, when looking at block crossing opportunities in other Alternative Trading Systems, the order flow is typically uncommitted. In an embodiment, the Trade Implementation and Analytics system 101 can allow the user to mark a committed order (e.g., set a flag on a data table) to indicate that it should participate in a crossing opportunity if one is available. As an order is working in an algorithm 140, a crossing system (e.g., BlockCross, Liquidnet, ITG Posit, or any other system) can send a signal to indicate a block trading opportunity. When this type of block trade opportunity is available, a message can be sent to the user to indicate the presence of the opportunity and receive input from the user as to their willingness to participate in a block trade. For example, the users can indicate the quantity of shares they will make available to cross (i.e. trade). Once a quantity available for crossing is indicated, the system can reduce the amount available to one or more algorithms 140 by that quantity, or temporarily cancel the order in its entirety so the trader is not trading against himself during the crossing opportunity. As described, the order information provided to a trading algorithm 140 consists of committed orders. In operation, at any given time, there is a difference between the number of committed orders available (i.e., yet to be executed), and the quantity of orders that have been executed. When a quantity is indicated for crossing, the system must remove that amount from the algorithmic server 140 until the cross is executed. If a cross is executed for less than the indicated quantity (i.e., it is executed for the lower of the two parties indicted quantities), then the remaining shares are made available for the algorithm 140. This process is a departure from existing crossing systems in that the orders within the trading algorithms 140 are committed orders. Crossing systems known in the art are generally configured to receive uncommitted order flow from an OMS (i.e., open orders) in an effort to create liquidity.

In operation, order information on an OMS 102 is sent to the Trade Implementation and Analytics system 101 via the communication link 106 (e.g., FIX) and can flow through the Trade Implementation and Analytics system 101 to one or more algorithmic servers 140. In general, the order information resides on the servers at the client sites (e.g., a bank) once it is sent from the OMS 102. A replicated portion of the order information can also reside on the from the Trade Implementation and Analytics system 101. For example, at least one field in the order information can be set by a user (e.g., a trader with access to an OMS 102) to indicate that they would like to participate in block crossing opportunities if available. The Trade Implementation and Analytics system 101 can be in communication with an ATS (e.g., BlockCross, Liquidnet, ITG) and configured to receive information about the orders within an ATS. Communications with the algorithmic servers 140, OMS systems 102, ATS and other servers can use existing network topologies, and known communications protocols. In an example, the Trade Implementation and Analytics system 101 can send a message (e.g., via FIX protocol) to a user to indicate that a contra order exists on an ATS for a committed order that is currently in an algorithmic server. Similarly, the ATS can be configured to send a message to the trader responsible for the contra order to alert the trader that a potential match exists. In an embodiment, the user (i.e., an individual responsible for the order on the algorithmic server 140), and the trader (i.e., an individual responsible for the contra order) can elect to let matching orders execute automatically, and/or they can elect to confirm the quantity they are willing to execute. In general, the orders can be executed at the midpoint of the NBBO price; however, other known pricing and negotiation processes are within the scope of this disclosure.

In an embodiment, once the order and contra-orders are matched, the Trade Implementation and Analytics server 101 can send a message (i.e. via FIX) to cancel the balance of the orders on the bank's algorithmic server 140, and then send an actual order to the ATS (i.e., the crossing server). The ATS can return information indicating that the order was completely filled, partially filled, or nothing (i.e. zero filled). Any executions returned from the ATS will flow back to the user's OMS 102. If the ATS returns a partial or a zero, then the balance of the orders can be reloaded onto an algorithmic server 140. This process can iterate through the trading day as block crossing opportunities appear on the ATS.

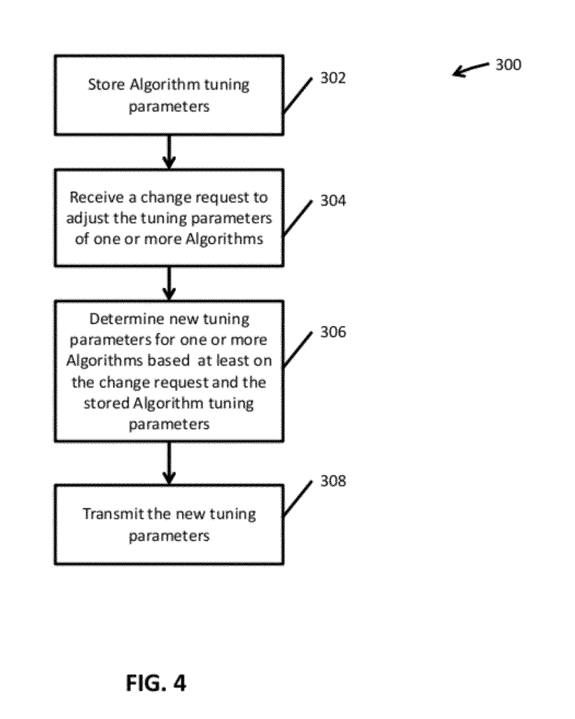

In operation, referring to FIG. 4, with further reference to FIGS. 2 and 3, a process 300 for normalizing algorithmic trading parameters using the Trade Implementation and Analytics system 101/102 includes the stages shown. The process 300, however, is exemplary only and not limiting. The process 300 may be altered, e.g., by having stages added, removed, or rearranged.

At stage 302, the N-engine 110 can store algorithm tuning parameters. In an embodiment, the N-engine 110 provides an interface to allow a trader to apply insight to trades executed by one or more algorithm trading systems 140. In general, before the day starts, a trader may have a preconceived notion based on general market date (e.g., news articles, CNBC stories) that a particular segment will be weak or strong. For example, a user may believe banks will perform particularly poorly because of news about the mortgage crisis. Hence, a buyer will be patient in buying because there will be a downward bias associated with banking Once the day starts, the user may want to have the ability to look at the performance of one or more algorithms based on their benchmarks (e.g., volume and price metrics), and potentially adjust the strategy associated with one or more algorithms. In many cases, with the prior art systems, a user will just “set and forget” the trading algorithm at the beginning of the day. An important facet of the N-engine 110 is that it provides a user with an ability to react to actual market conditions. The measurement aspects of the invention provide feedback to the user to enable them to make the adjustments.

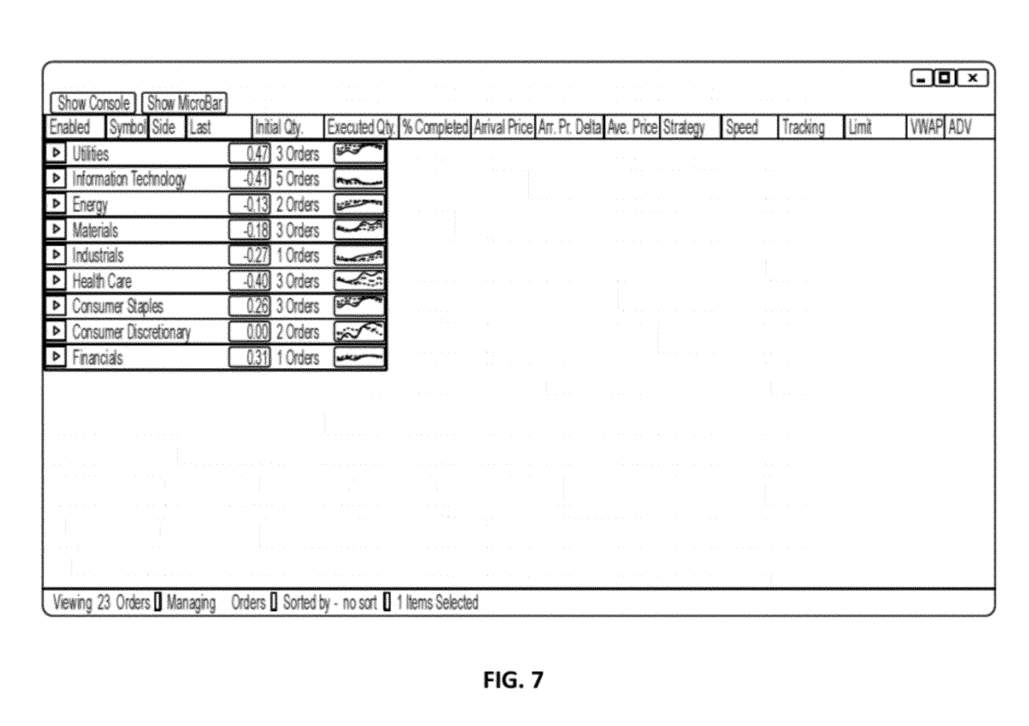

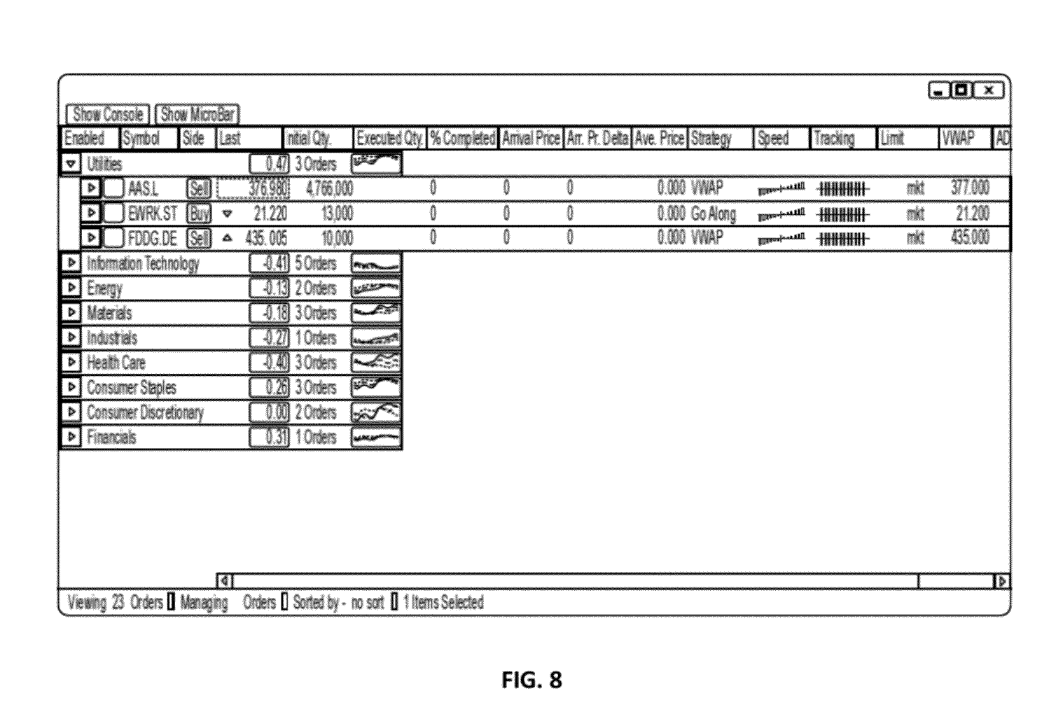

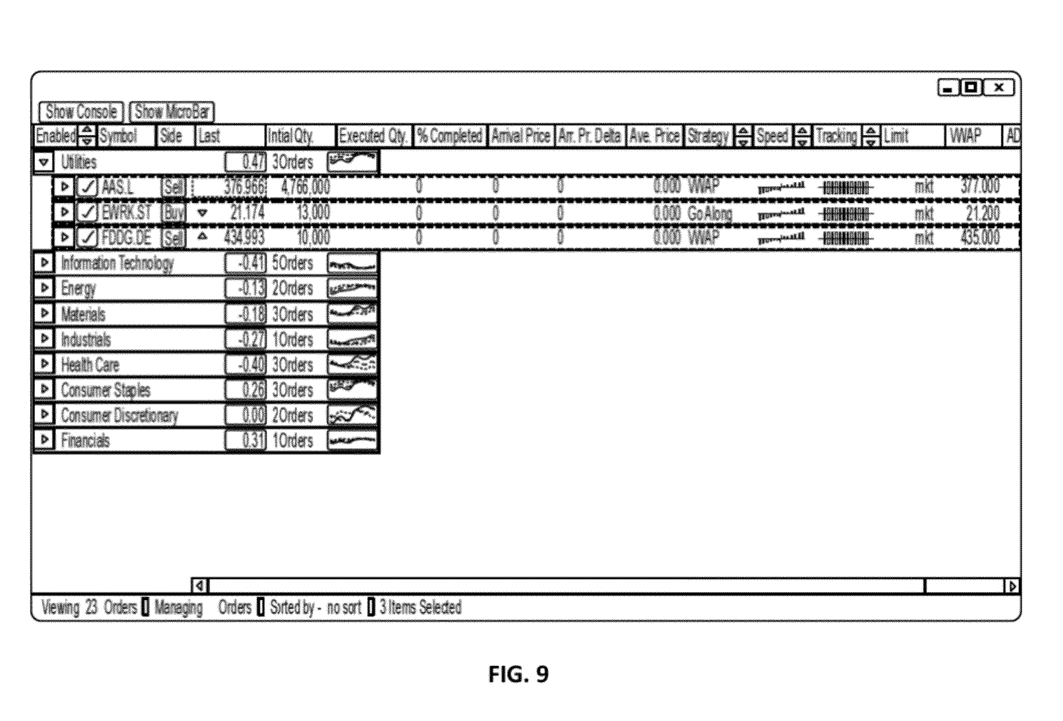

At stage 304, the N-engine 110 can receive a change request to adjust the tuning parameters of one or more algorithms. In an embodiment, the Trade Implementation and Analytics systems 101/201 can include a Graphical User interface 104 to enable a user to view and update data associated with their orders and corresponding algorithms 140. The Trade Implementation and Analytics systems 101/201 can be accessed via the web in a Software as a Service (i.e., thin client) model, or via a rich client application installed computer system at the client's site. Referring to FIG. 7, an exemplary user interface for implementing Trade Implementation and Analytics process across an industry group is shown. The groups are exemplary only and not a limitation as other industry groups can used. An objective for the interface is to provide the user with a summary of the orders they are working, highlight any performance issues, and provide the user an opportunity to expand an industry group and view the corresponding orders (see FIG. 8). Rules and conditions regarding the performance of stocks and the associated trading algorithm parameters 140 can be stored. In an embodiment, referring to FIG. 9 with further reference to FIG. 1A, the change request can be created by selecting an arrow GUI object associated with the strategy, speed, and tracking fields for one or more names. Other GUI fields can be used to create a change request. The N-engine 110 can convert the user's selection on the GUI to a change request via the UI process components 15 and/or the rules component 19. At stage 306, the N-engine 110 can determine new tuning parameters for one or more algorithms based at least on the change requested and the stored tuning parameters. For example, the N-engine 110 can utilize the rules component 19 and the data access component 20 to access a collection of parameters stored on a data source 24 to output new tuning parameters.

In an embodiment, the Trade Implementation and Analytics system 101 can connect to the algorithmic server 140 at a bank via that server's existing API or web service. For example, many banks allow traders to access parameters associated with the bank's algorithmic trading program via an API or web server. In general, the trader can adjust the parameters on an order by order basis. In the prior art, if a trader is responsible for a collection of orders across more than one bank (i.e., more than one algorithmic server), then the trader must log onto each algorithmic server individually and adjust the parameters on an order by order basis. The Trade Implementation and Analytics system 101, however, can eliminate this task for the trader. At stage 308 the N-engine 110 can transmit the new tuning parameters. For example, in an embodiment, the Trade Implementation and Analytics system 101 can communicate with a plurality of algorithmic servers 140, normalize the input received from the trader, and adjust the algorithm parameters across the plurality of servers 140 based on the single input received from the trader. In an embodiment, the Trade Implementation and Analytics system 201 can provide the new tuning parameters to the OMS 102 via the communication link 206.

It is important to note that it is common for a trading firm to create a new trading algorithm when the firm wants to adjust the parameters of an existing algorithm trading routine. This solution, however, can present significant problems based on the robust requirements for a trading algorithm. In general, an institutional trading algorithm must be capable of processing at extremely high volumes, and each processed order must stand up to a high level of scrutiny from the firm's customers, as well as regulators. Therefore, the level of development and testing required can be substantial. As is generally known in the art, poorly designed trading algorithms are often pointed to as a likely source of recent “flash crashes.” Thus, the normalization process of the N-engine 110 can provide the benefit of leveraging existing, and robust, trading algorithms.

The N-engine 110 provides an alternative to building a new trading algorithm by allowing a trader to more easily implement their insight to existing (i.e., robust) trading algorithms. For example, if a trader's insight believes that a segment of the market will increase over the next hour, then he can adjust one or more algorithms to buy a bit faster and sell a bit slower for a given order (or set of orders). As a result, the weighted averages of that trader's actual executions are likely to perform better than orders executed by a trading algorithm alone that has not been modified.

In an embodiment, the N-engine 110 can include macros and more sophisticated processes (e.g., control optimization programs) to adjust the trading algorithms (i.e., apply insight) based on current market conditions, historical performance associated with a particular algorithm, or empirical data which can be processed by a computer. The GUI 104 interface can enable such optimization because the manual processes known in the art are incapable of reaction times required by the market. For example, if the chairman of the Federal Reserve Bank were to make an announcement regarding a raise in interest rates, the impact on the market is almost immediate. A trader, and the current algorithmic trading infrastructure, cannot adjust the parameters associated with the trading algorithms fast enough to react to the announcement.

Referring to FIG. 9, the GUI 104 can be configured to allow a trader to adjust the parameters associated with an algorithm. Many trading algorithms include parameters such as Strategy, Speed, and Tracking limits which can be adjusted to modify the operation of algorithm. As indicated in FIG. 9, the orders shown employ various named strategies; VWAP, Go Along, and Arrival Price. Other proprietary names of strategies (e.g., Sniper, Guerilla, Stealth) can also be used. All orders shown are set to default “Speed” and “Tracking” levels. Taken individually, these parameters can have different and potentially proprietary titles (e.g., “aggressive,” “passive”) based on the algorithm's owner and corresponding strategies. One of the features of the N-Engine 110, therefore, is to normalize the interface such that user need only select from a limited set of parameters to cause each of the proprietary trading algorithms 140 to perform in an expected manner.

The GUI 104 can allow a user to adjust these parameters for multiple orders across multiple algorithmic servers 140. For example, assuming a trader has multiple buy orders in the Utilities industry segment and the trader believes the prices for shares in the Utilities will be increasing throughout the day. The trader can increase the “speed” parameter associated with the trading algorithm(s) to buy more aggressively for any or all of the orders in the industry segment. Similarly, if the trader has sell orders in the Utility industry, they can decrease the “speed” parameter to cause more executions later in a given time horizon, as compared to the algorithm, when they expect prices to be higher.

In an example, the trader can adjust a “Tracking” parameter to instruct the algorithm to be loose or tight (e.g., tolerant) to the transaction strategy based on the volume of transactions as compared to time. That is, if a trader sets the “Tracking” parameter to tight (i.e. intolerant in terms of tracking to volume expectations), then he will not be patient about letting orders come to him and is risking a larger impact on price.

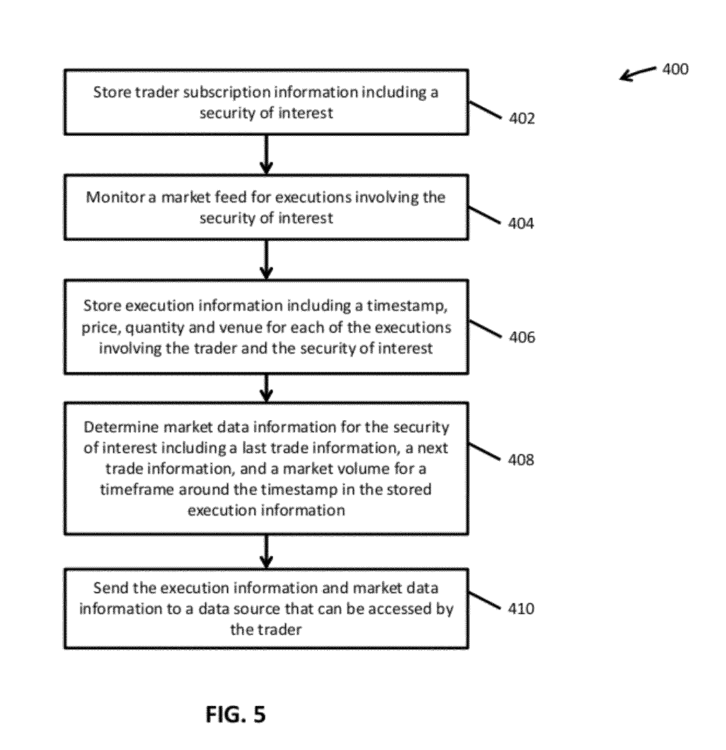

Referring to FIG. 5, with further reference to FIGS. 2 and 3, a process 400 for providing subscription based analytic data to a trader using the A-engine 120 includes the stages shown. The process 400, however, is exemplary only and not limiting. The process 400 may be altered, e.g., by having stages added, removed, or rearranged.

At stage 402, the A-engine 120 can store a trader's subscription information including a security of interest (e.g., trader ID information, a name of a security). In an embodiment, the trader can provide an update interval to indicate how often they would like to update their subscription data. For example, a user 12 can utilize the GUI 104 to enter a name of interest and may also indicate an update interval (e.g., 1, 2, 3, 4, 5, 10, 15 minutes). The user's information can be stored in a subscription database which is accessible via the data access component 20.

At stage 404, the A-engine can monitor a market feed for executions involving the security of interest. For example, the A-engine can utilize the service interfaces component 16 to access a third party data service or similar market feed (e.g., Bloomberg, Reuters). Executions and other market data corresponding to the user's names can be retrieved. As an example, at stage 406, the A-engine 120 can store execution information including a timestamp, price, quantity and venue for each of the executions involving the trader and the security of interest. At stage 408, the A-engine 120 can determine market data information for the security of interest including last trade information, next trade information, and a market volume for a timeframe around the timestamp in the stored execution information. Other market related data can also be monitored and stored (e.g., offer quantity and price, bid quantity and price, inside quote information including shares offered at each price, market volume over defined time periods, the next best offer/bid quantities and prices, and venue information). In an embodiment, the market data can include the size of trades executed and the size that was shown in one or more venues. For example, bid and offer for each venue, the best bid from any venue, and the best offer from any venue can be stored by the A-engine 120. In an embodiment, the timeframe around an execution can be measured in a number of updates (e.g., 1, 2, 3, 4, 5) for the name. For example, for each of the trader's executions the current bid and offer can be stored, as well as one or more previous bids and offers and subsequent bids and offers for the name (i.e., previous and subsequent quotes). In an embodiment, the market data information can include the price, quantity and venue of the previous and subsequent trades (i.e., printed executions of the name that do not involve the trader). The A-engine 120 can also receive information about unfilled orders. That is, information about orders that are sent by an algo but are not successful.

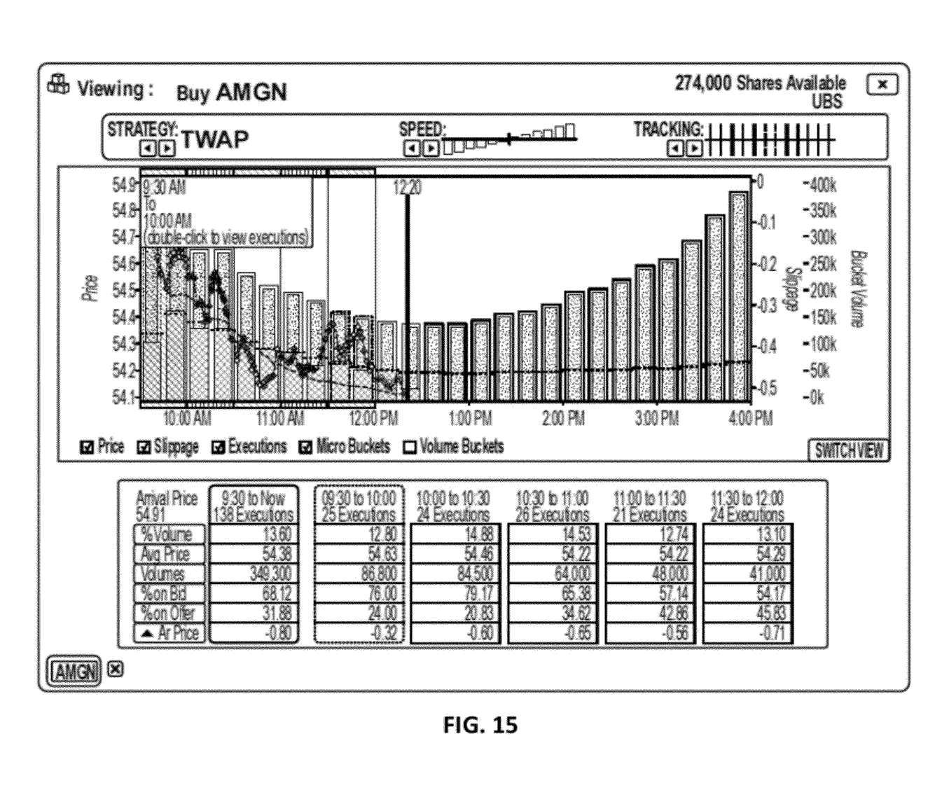

At stage 410, the A-engine can send the execution information and market data information to a data source that can be accessed by the trader. (e.g., the user's OMS, a networked RDMS, the GUI 102). In an embodiment, the A-engine 120 can utilize a data access component 20 and/or a service interface 16 to provide information to a user 12. For example, in an embodiment, referring to FIG. 15, an exemplary A-engine 120 user interface illustrating near real-time feedback of the performance of an algorithm associated with one or more orders is shown. In general, a trading algorithm can establish a distribution for a given time horizon to buy or sell a stock. In most cases the time horizon is based on a day, or a portion of a day. For example, if a trader needs to buy or sell 100,000 shares, they cannot put that entire amount on the market as a single transaction without affecting the market price. Therefore, the trading algorithm can distribute the 100,000 shares over the time horizon and attempt to complete several smaller transactions during that time period. Further, the algorithms can include historical trends on the times for trading and can therefore attempt to transact a number of shares based on those trends. The algorithms can also determine when to transact the orders, or when to be passive, based on market responses.

In an embodiment, the A-engine GUI 104 can allow the trader to review the performance of their transactions and corresponding strategy on a near real-time basis. The ability to look at the transactions over a small window of time (i.e., intervals of minutes), allows the user to assess the combination of the performance of the trading algorithm and the trader's insight (i.e., parameter adjustments). Further, the GUI 104 can allow the user to adjust the parameters of the algorithm in response to the performance feedback. For example, an algorithm can provide data about the projected volume associated with an order and the planned transactions based on that volume data. If the performance indications on the GUI 104 indicate that the price is decreasing, the trader can increase the “speed” parameter to increase (i.e. pull in the time of) the planned transactions. The GUI 104 can allow the trader to apply his insight in near real time across several orders and multiple algorithm servers.

Referring to FIG. 15, the GUI 104 screen shot illustrates that an order for AMGN in expanded form. The graph depicts a series 30 minute time buckets, and the execution data contained therein. The current time is 12:20, as seen above the vertical line on the graph. Bucket volumes, projected and actual, for the trader's order can be represented by the column series, overlaid atop the actual bucket-volumes for the security itself. Slippage is represented by the line series, and the trader's executions are individually plotted in the scatter series.

An algorithm may have average performance when measured over a day, but have superior or inferior performance when measured over short (e.g., 15 minutes) intervals. The A-engine allows analysis of performance over short discrete time intervals and thus increases the insight of a trader into when to use which algorithm.

The time intervals illustrated in FIG. 15 are exemplary only and not a limitation. The GUI can be configured to display other time intervals and can enable a trader to perform discrete interval analysis in near real time. For example, a trader can analyze multiple time intervals (e.g., 2, 3, 4, 5, 6) to evaluate execution performance in each of the intervals. In an embodiment, the GUI 104 can accept information from the trader to define and store interval data based on other system variables such as industry, stock, algorithm, user and performance. For example, a user can create and save a standard desktop, including interval definitions, which are displayed whenever that user selects a stock. In an embodiment, the trader can create intervals on an ad hoc basis to analyze intra-day performance of an algorithm.

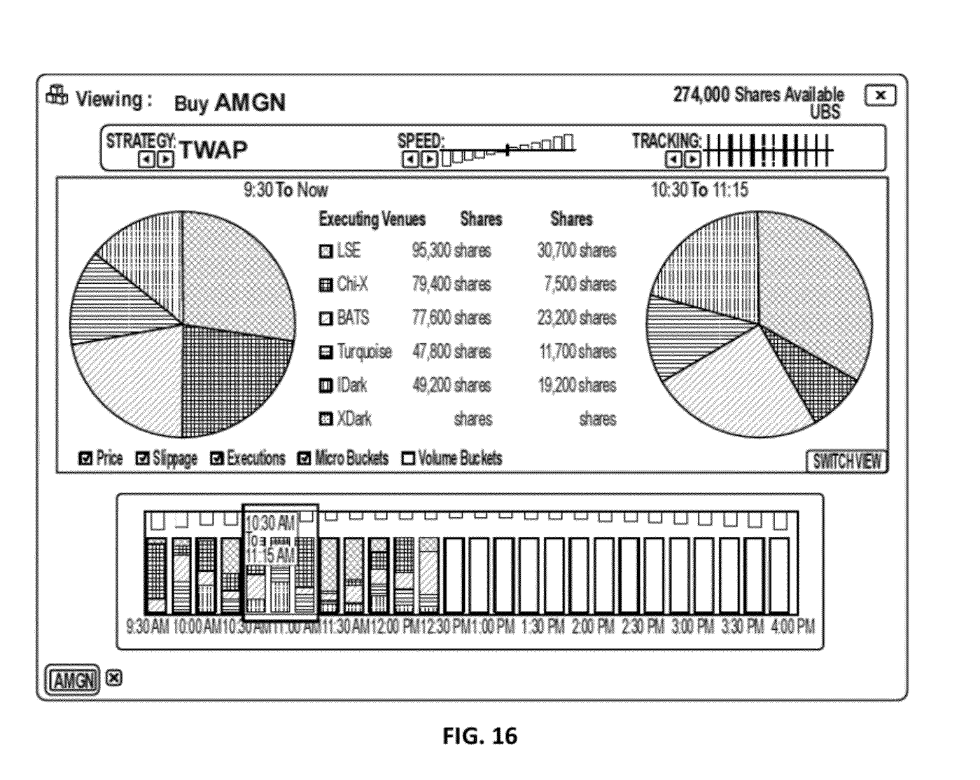

Referring to FIG. 16, an exemplary user interface for reviewing execution venue information associated with a name and time interval is shown. In an embodiment, the data behind the user interface is based on the execution information stored by the A-engine 120. The screen shot shows the cumulative executions from the start of the day (i.e., 9:30 to Now), and the executions over an interval (i.e., 10:30 to 11:15). The different sections of the pie charts and the bar graphs indicate the venues where executions are being performed. This information can be important to a trader because it allows them to verify that their broker is utilizing a wide range of potential liquidity sources. For example, it can held a trader determine if a broker is favoring the liquidity sources where the broker has a financial advantage or other conflicting incentive. The trader may also utilize this venue information to determine the quality of executions based on the destination (i.e., some destinations may not be providing as good of a result). The bar charts in the bottom window can have an adjustable time interval (i.e., 5, 10, 15, 30 mins) to illustrate relative number of executions in each venue.

In an embodiment, the A-engine 120 can assign a performance score to each algo 140 based on the relative execution performance of each algo in view of market data such as security, industry, market price, volume, and/or venue information captured by the A-engine 120. The score can help a trader determine which algo to use (i.e., send an order to). As an example, and not a limitation, the trader may also use their commission budget in combination with the performance score to determine which algo to use. For example, if the trader's firm owes a broker for prior research (i.e., the commission budget), the amount owed can be used as a factor in deciding whether or not to select one of that broker's algos 140. In an embodiment, the performance factor can be the primary decision factor, and the commission budget can be a secondary decision factor.

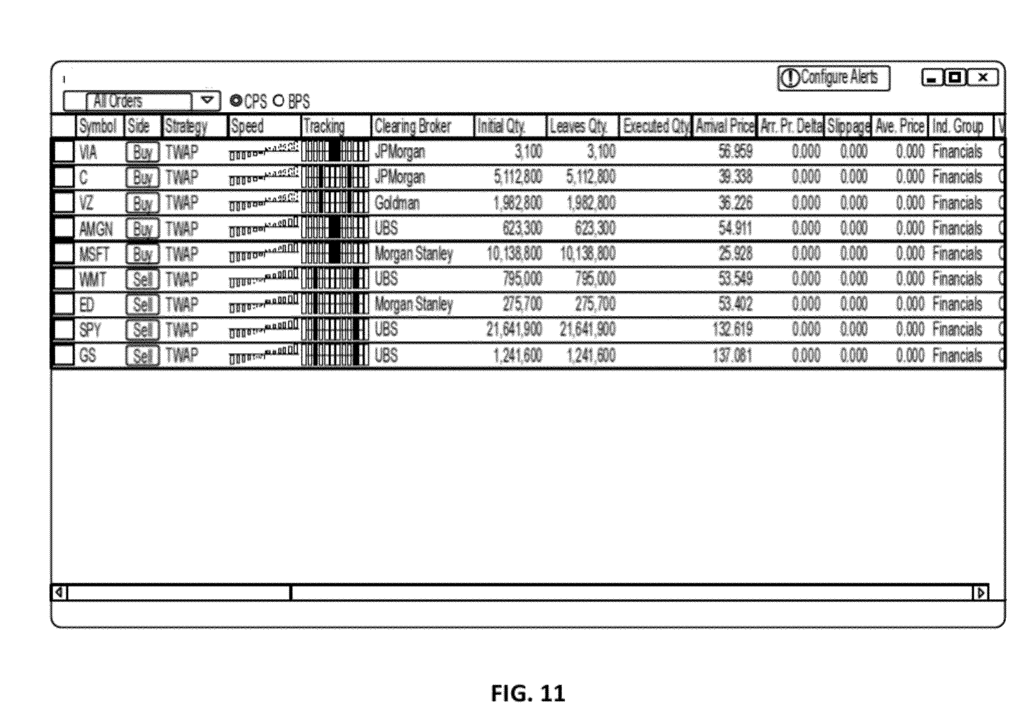

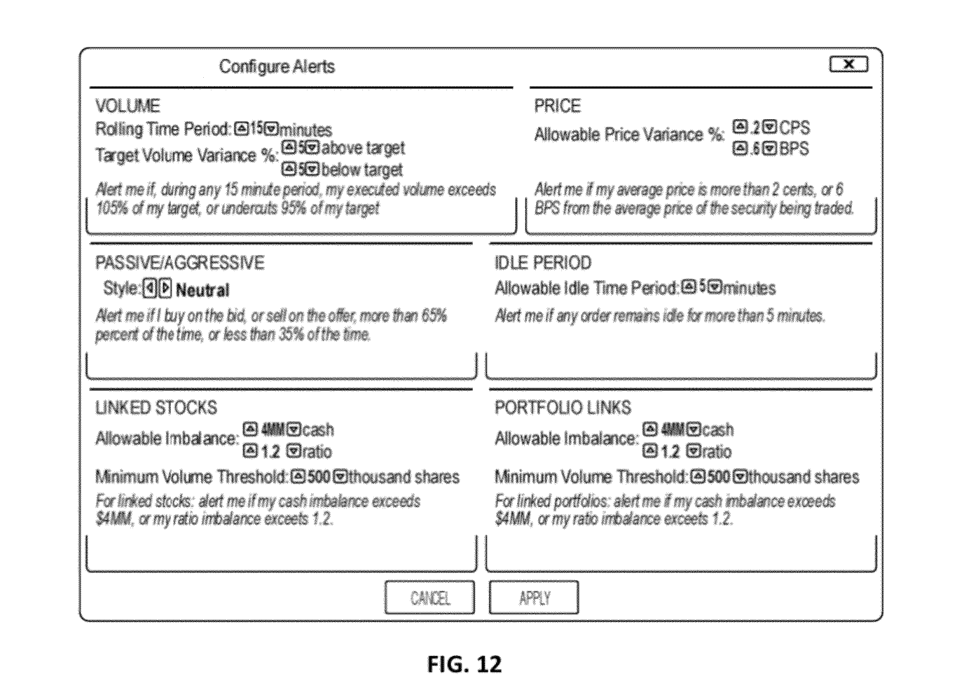

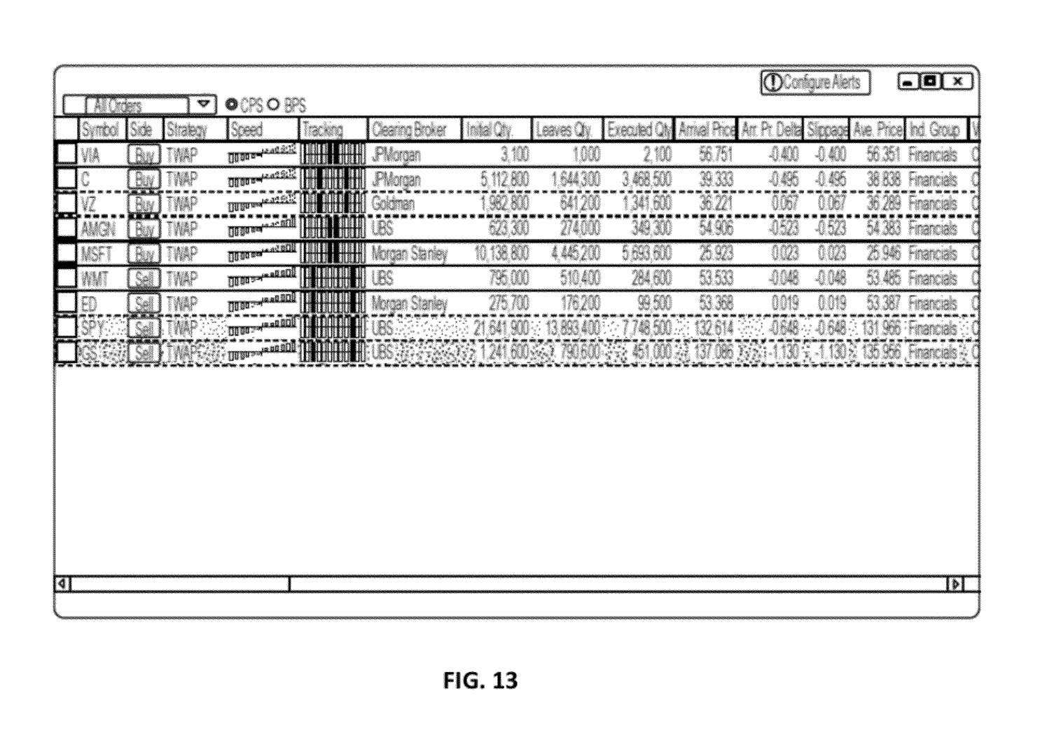

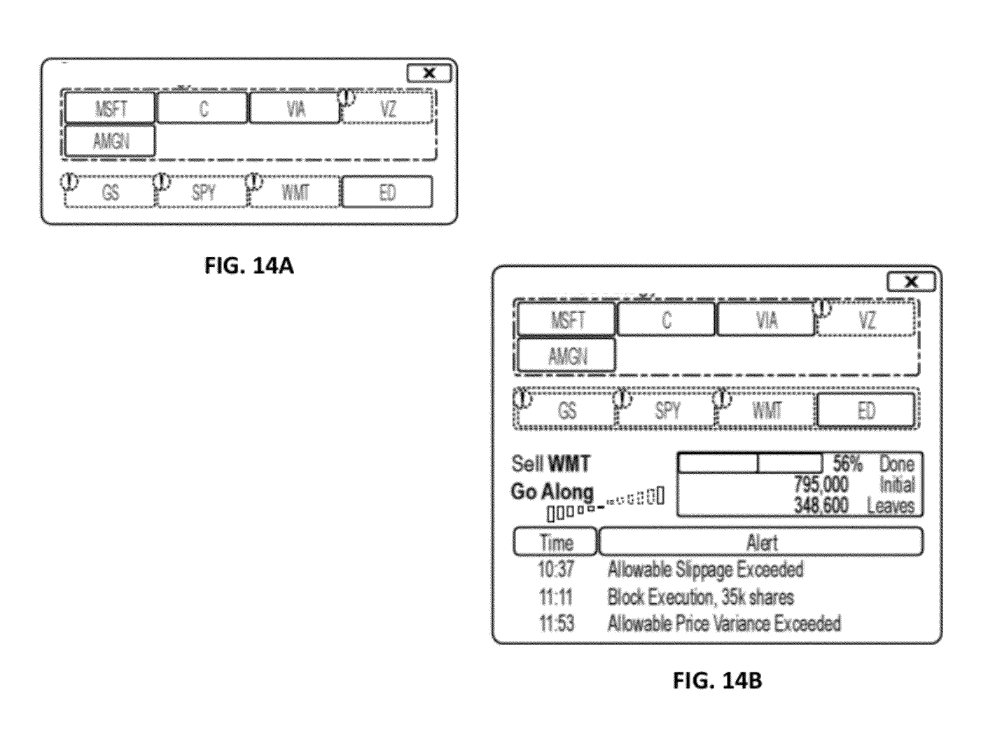

Referring to FIG. 11, an exemplary user interface for implementing the Trade Implementation and Analytics system across a collection of names, including a control to configure alerts for one or more of the names is shown. In an embodiment, a user can select an order and then activate a “Configure Alerts” object to active an alert function in the A-engine 120. Referring to FIG. 12, a user can establish alerts for parameters such as Volume, Price, Passive/Aggressive, Idle Period, Linked Stocks and Portfolio links. For example, an allowable price variance can be entered in the GUI and the A-engine can be configured to alert the user if the average price exceeds a threshold (e.g., if the average price is more than 2 cents, or 6 BPS from the average price being traded). The GUI can facilitate the entry of the threshold via form objects such as up and down arrows to change (e.g., increment or decrement) allowable threshold values. The triggered alerts could indicate to the trader that something may be wrong with the trading strategy they are trying to deploy (i.e., the strategy is not effective). Referring to FIG. 13, the GUI can highlight the orders that are in an alert status. For example, the row of a name can flash or change color based on the subject or type of the alert (e.g., an alert for volume can be one color, while an alert for price can be a different color). The different stippling on FIG. 13 simulates visual differences such as background color, text color, or flashing. Similarly, referring to FIGS. 14A and 14B, pop-up windows can be presented to a trader when an alert is triggered. The pop-up windows can be configured to show more or less detail.

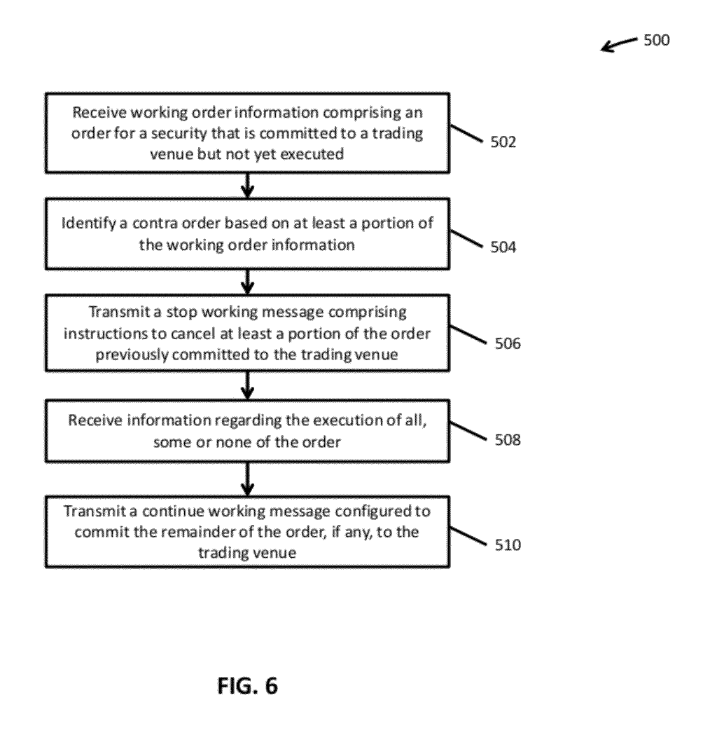

In operation, referring to FIG. 6, with further reference to FIG. 2, a process 500 for providing crossing opportunities to orders currently committed to banking algorithms using the C-engine 130 includes the stages shown. The process 500, however, is exemplary only and not limiting. The process 500 may be altered, e.g., by having stages added, removed, or rearranged.

In general, in the prior art, most Alternative Trading Systems cross orders in one of two ways. In the first circumstance, traders can send firm orders to a dark pool for a finite period of time to see if a contra-orders is available to trade. That is, a firm order goes into a dark pool and has a lifespan of a few seconds, minutes, or hours to see if there is a response. This scenario can require a substantial amount of work on the part of the trader when they are responsible to work hundreds of orders in a day. Hence, in a second circumstance, a liquidity provider can scrape the blotter of a buy-side OMS to get a picture of the quantities of orders that are unassigned. This data is then crossed on a database to find contra-orders and the traders on both sides can be alerted to a potential trade. This process can reduce the amount of work on the traders because the opportunity is being presented without the traders sending firm orders to the dark pools. A problem with scraping uncommitted (i.e., unassigned) orders is that a buy-side trader is constantly working the orders in their blotter and thus assigning them to potential execution venues (e.g., algos, dark pools). These assigned orders are therefore not generally available to be scraped (i.e., because they are committed orders).

Thus, at stage 502, the C-engine 130 can receive working order information comprising an order for a security that is committed to a trading venue but not yet executed. In an embodiment, the OMS 102 sends orders to the algos 140 through the N-engine 110 in the Trade Implementation and Analytics system 101. Other working order information can also flow to the N-engine 110, and the A-engine 120. For example, referring to FIG. 3, the Trade Implementation and Analytics application 201 can receive working order information via the communication link 206. In an embodiment, the working order information need only contain enough information to identify a contra order on crossing system (i.e., the requirements for matching contra orders can vary with each ATS). In an embodiment, the N-engine can receive working order information that is sufficient to execute a crossing opportunity. At stage 504 the C-engine 130 can identify a contra order based on at least a portion of the working order information. In an embodiment, the C-engine 130 is aware of the working order flow in the system 101, and can provide at least a portion of a working order information to a crossing system. When a contra-order is identified, the ATS can send a notification to the C-engine 130 of a potential crossing opportunity. In an embodiment, the C-engine 130 can identify a contra-order without sending information to an ATS (i.e., the C-engine 130 can be a crossing system).

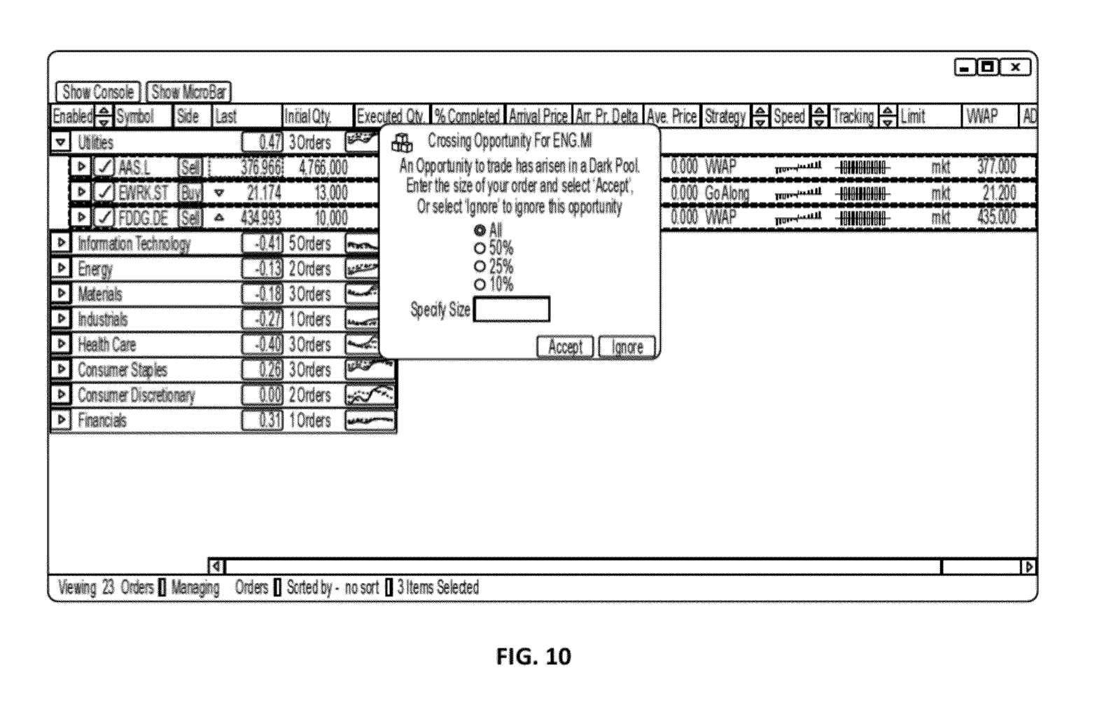

Referring to FIG. 10, the trader can receive an alert from the C-engine 130 of the crossing opportunity. If the trader indicates that they would like to participate in the crossing opportunity (e.g., 100%, 80%, 50%, 30%, or other value), at stage 506 the C-engine 130 can transmit a stop work message comprising instructions to cancel at least a portion of the order previously committed to the trading venue. In an embodiment, the C-engine 130 can provide instructions to the OMS 102 to pull back the orders in one or more of the algos 140 (i.e., canceled out of the algo). Other pull back strategies can be used (i.e., by canceling only a subset of the working orders), in view of market conditions and trading venues. For example, if the orders are in the pole position of an algo 140, they may be propping up the price of the security at the time the trader is seeking to commit to a crossing opportunity. Thus, it may be that the trader will want all of the orders working the algo 140 canceled before committing to the crossing opportunity. In an embodiment, the stop working message can be sent directly to one or more algos 140 from the system 101.

At stage 508, the C-engine can receive information regarding the execution of all, some or none of the order. In an embodiment, once the OMS 102 receives a confirmation of the execution of the crossing opportunity (e.g., partial, full, nothing), then at stage 510 the C-engine 130 can transmit a continue working message configured to commit at least a portion of the remainder of the order, if any, to the trading venue. For example, the remainder of the order (if any) can be re-submitted to the algo 140 in the appropriate state. In an embodiment, the continue working message can be a FIX message containing information to commit at least a portion of the remainder to an algo 140. In an embodiment, referring to FIG. 3, the continue working message can be sent to an OMS via the communication link 206, wherein the OMS can be configured to send a FIX message to commit at least a portion of the remainder to an algo 140.

In an embodiment, the trader can establish rules in the OMS 102, or the C-engine 130 to automatically execute a crossing opportunity when alerted. For example, if 25% of an order has been completed, and the market has not moved up Xpoints in the last 10 minutes, then automatically commit to 10% of the balance of the orders, with a minimum of X. A rules engine can emulate the traders though process/analysis in deciding to participate in a crossing opportunity.

In an embodiment, components from the A-engine 120 can be used to inform the trader of the current environment (e.g., smooth sailing, jumpy, other conditions) when the crossing alert is received. The A-engine 120 can inform the C-engine's rules component 19 to make a recommendation. For example, the A-engine 120 can show where the trader is in the trade and what the opportunity would do to the average price. For example, the GUI can display where the trader is (i.e., the trader's average price in the trade), and the trader's projected average price. Other analytic information can be displayed: variable time buckets, the percentage of volume the trader is, what is the trader's average price, what's the overall volume, percent on the bid and offer, price delta.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A computerized method for adjusting the performance of a plurality of trading algorithms, comprising:
storing algorithm tuning parameters;
receiving a change request to adjust the tuning parameters of one or more algorithms;
determining new tuning parameters for the one or more algorithms based at least on the change request and the stored algorithm tuning parameters; and
transmitting the new tuning parameters.

2. The computerized method of claim 1 wherein the change request includes a name of a strategy to be employed by the algorithm.

3. The computerized method of claim 2 wherein the name of the strategy is selected from the group consisting of VWAP, TWAP, Go Along, Arrival Price, Sniper, Guerilla, and Stealth.

4. The computerized method of claim 1 wherein the change request includes a speed parameter.

5. The computerized method of claim 1 wherein the change request includes a tracking parameter.

6. The computerized method of claim 1 wherein transmitting the new tuning parameters includes transmitting the new parameters to one or more algorithm servers via a FIX message.

7. The computerized method of claim 1 wherein transmitting the new tuning parameters includes transmitting the new parameters to an OMS via a FIX message.

8. A computerized method for providing subscription based analytic data to a trader, comprising:
storing trader subscription information including a security of interest;
monitoring a market feed for executions involving the security of interest;
storing execution information including a timestamp, price, quantity and venue for each of the executions involving the trader and the security of interest;
determining a market data information for the security of interest including a last trade information, a next trade information, and a market volume for a timeframe around the timestamp in the stored execution information; and
sending the execution information and the market data information to a data source that can be accessed by the trader.

9. The computerized method of claim 8 wherein the market data information for the security of interest includes best offer quantity and price and best bid quantity and price in the execution venue for the timeframe around the timestamp in the stored execution information.

10. The computerized method of claim 8 wherein the market data information for the security of interest includes best offer quantity and price and best bid quantity and price in a plurality of venues for the timeframe around the timestamp in the stored execution information.

11. The computerized method of claim 8 wherein the market data information for the security of interest includes the next best offer quantity and price and the next best bid quantity and price for a timeframe around the timestamp in the stored execution information.

12. The computerized method of claim 8 wherein the market data information includes a price, a quantity and a venue of the previous and subsequent trades of the security of interest.

13. The computerized method of claim 8 wherein the timeframe around the timestamp in the stored execution information includes two updates before the execution and 5 updates after the execution.

14. The computerized method of claim 8 wherein an OMS is a data source that can be accessed by the trader.

15. The computerized method of claim 8 wherein a networked relational database system is a data source that can be accessed by the trader.

16. The computerized method of claim 8 comprising sending an alert to the trader based on the execution information and the market data information.

17. A computerized method for providing a crossing opportunity for an order for a security that is committed to a trading venue, comprising:
receiving a working order information comprising an order for a security that is committed to a trading venue but not yet executed;
identifying a contra order based on at least on a portion of the working order information;
transmitting a stop working message comprising instructions to cancel at least a portion of the order previously committed to the trading venue;
receiving information regarding the execution of all, some or none of the order; and
transmitting a continue working message configured to commit at least part of the remainder of the order to the trading venue, if a part of the order was not executed.

18. The computerized method of claim 17 wherein identifying a contra order comprises:
providing at least a portion of the working order information to a crossing system; and
receiving an indication of interest for a contra order from the crossing system.

19. The computerized method of claim 17 comprising:
sending an alert to a trader to inform them of the contra order; and
receiving an indication from the trader to attempt to execute a trade based on the contra order.

20. The computerized method of claim 17 wherein the continue work message is sent to an OMS.
